(19) United States
(12) Patent Application Publication
(10) Pub. No.: US 2009/0125396 A1
(43) Pub. Date: May 14, 2009

(54) System and method for generating and transmitting location based promotional offer reminders

(75) Inventors: Jonathan Otto, Palm Beach, FL (US); Andrew Van Luchene, Santa Fe, NM (US); Raymond J. Mueller, Palm Beach Gardens, FL (US); Michael R. Mueller, San Francisco, CA (US)

Correspondence Address: SIMPSON & SIMPSON, PLLC, 5555 MAIN STREET, WILLIAMSVILLE, NY, 14221-5406, US

(73) Assignee: RetailDNA, LLC, West Palm Beach, FL (US)

(21) Appl. No.: 12/217,826

(22) Filed: Jul. 9, 2008

Related U.S. Application Data
(63) Continuation-in-part of application No. 12/151,038, filed on May 2, 2008.
Application No. 12/151,038 is a continuation-in-part of application No. 11/983,679, filed on Nov. 9, 2007.
Application No. 11/983,679 is a continuation-in-part of application No. 09/993,228, filed on Nov. 14, 2001.

(51) Int. Cl. G06Q 30/00; G06F 15/16; G01C 21/00

(52) U.S. Cl. 705/14; 709/204; 701/300

(57) ABSTRACT

A computer-based system for generating and transmitting a location based offer reminder, including: an interface element for at least one specially programmed general-purpose computer; a memory element for the computer, the memory element storing a record of at least one communication sent to at least one wireless communications device (WCD); and a reminder element, in a processor for the computer. The reminder element is for: identifying, using the interface element, the at least one WCD as being within a prescribed geographical area; determining that a response to the communication has not been received; generating at least one reminder regarding the communication; and transmitting, using the interface element, the reminder to a wireless communications network for transmission to WCD. In one embodiment, the reminder element generates the at least one reminder using at least one of a set of rules or an artificial intelligence program stored in the memory unit.

### CROSS-REFERENCE TO RELATED APPLICATIONS

This is a continuation-in-part patent application under 35 USC 120 of U.S. patent application Ser. No. 12/151,038, filed May 2, 2008 and entitled “Method and Apparatus for Generating and Transmitting an Order Initiation Offer to a Wireless Communications Device” and of U.S. patent application Ser. No. 12/151,043, filed May 2, 2008 and entitled “Method and System For Centralized Generation of a Business Executable Using Genetic Algorithms and Rules Distributed Among Multiple Hardware Devices,” which is a continuation-in-part of U.S. patent application Ser. No. 11/983,679, filed Nov. 9, 2007 and entitled “Method and System for Generating, Selecting, and Running Executables in a Business System Utilizing a Combination of User Defined Rules and Artificial Intelligence” which is a continuation-in-part patent application under 35 USC 120 of U.S. patent application Ser. No. 09/993,228, filed Nov. 14, 2001 and entitled “Method and apparatus for dynamic rule and/or offer generation,” which applications are incorporated herein by reference.

This application is related to: U.S. patent application Ser. No. 09/052,093 entitled “Vending Machine Evaluation Network” and filed Mar. 31, 1998; U.S. patent application Ser. No. 09/083,483 entitled “Method and Apparatus for Selling an Aging Food Product” and filed May 22, 1998; U.S. patent application Ser. No. 09/282,747 entitled “Method and Apparatus for Providing Cross-Benefits Based on a Customer Activity” and filed Mar. 31, 1999; U.S. patent application Ser. No. 08/943,483 entitled “System and Method for Facilitating Acceptance of Conditional Purchase Offers (CPOs)” and filed on Oct. 3, 1997, which is a continuation-in-part of U.S. patent application Ser. No. 08/923,683 entitled “Conditional Purchase Offer (CPO) Management System For Packages” and filed Sep. 4, 1997, which is a continuation-in-part of U.S. patent application Ser. No. 08/889,319 entitled “Conditional Purchase Offer Management System” and filed Jul. 8, 1997, which is a continuation-in-part of U.S. patent application Ser. No. 08/707,660 entitled “Method and Apparatus for a Cryptographically Assisted Commercial Network System Designed to Facilitate Buyer-Driven Conditional Purchase Offers,” filed on Sep. 4, 1996 and issued as U.S. Pat. No. 5,794,207 on Aug. 11, 1998; U.S. patent application Ser. No. 08/920,116 entitled “Method and System for Processing Supplementary Product Sales at a Point-Of-Sale Terminal” and filed Aug. 26, 1997, which is a continuation-in-part of U.S. patent application Ser. No. 08/822,709 entitled “System and Method for Performing Lottery Ticket Transactions Utilizing Point-Of-Sale Terminals” and filed Mar. 21, 1997; U.S. patent application Ser. No. 09/135,179 entitled “Method and Apparatus for Determining Whether a Verbal Message Was Spoken During a Transaction at a Point-Of-Sale Terminal” and filed Aug. 17, 1998; U.S. patent application Ser. No. 09/538,751 entitled “Dynamic Propagation of Promotional Information in a Network of Point-of-Sale Terminals” and filed Mar. 30, 2000; U.S. patent application Ser. No. 09/442,754 entitled “Method and System for Processing Supplementary Product Sales at a Point-of-Sale Terminal” and filed Nov. 12, 1999; U.S. patent application Ser. No. 09/045,386 entitled “Method and Apparatus For Controlling the Performance of a Supplementary Process at a Point-of-Sale Terminal” and filed Mar. 20, 1998; U.S. patent application Ser. No. 09/045,347 entitled “Method and Apparatus for Providing a Supplementary Product Sale at a Point-of-Sale Terminal” and filed Mar. 20, 1998; U.S. patent application Ser. No. 09/083,689 entitled “Method and System for Selling Supplementary Products at a Point-of Sale and filed May 21, 1998; U.S. patent application Ser. No. 09/045,518 entitled “Method and Apparatus for Processing a Supplementary Product Sale at a Point-of-Sale Terminal” and filed Mar. 20, 1998; U.S. patent application Ser. No. 09/076,409 entitled “Method and Apparatus for Generating a Coupon” and filed May 12, 1998; U.S. patent application Ser. No. 09/045,084 entitled “Method and Apparatus for Controlling Offers that are Provided at a Point-of-Sale Terminal” and filed Mar. 20, 1998; U.S. patent application Ser. No. 09/098,240 entitled “System and Method for Applying and Tracking a Conditional Value Coupon for a Retail Establishment” and filed Jun. 16, 1998; U.S. patent application Ser. No. 09/157,837 entitled “Method and Apparatus for Selling an Aging Food Product as a Substitute for an Ordered Product” and filed Sep. 21, 1998, which is a continuation of U.S. patent application Ser. No. 09/083,483 entitled “Method and Apparatus for Selling an Aging Food Product” and filed May 22, 1998; U.S. patent application Ser. No. 09/603,677 entitled “Method and Apparatus for selecting a Supplemental Product to offer for Sale During a Transaction” and filed Jun. 26, 2000; U.S. Pat. No. 6,119,100 entitled “Method and Apparatus for Managing the Sale of Aging Products and filed Oct. 6, 1997 and U.S. Provisional Patent Application Ser. No. 60/239,610 entitled “Methods and Apparatus for Performing Upsells” and filed Oct. 11, 2000.

By “related to” we mean that the present application and the applications noted above are in the same general technological area and have a common inventor or assignee. However, “related to” does not necessarily mean that the present application and any or all of the applications noted above are patentably indistinct, or that the filing date for the present application is within two months of any of the respective filing dates for the applications noted above.

### FIELD OF THE INVENTION

The invention relates generally to a method and system for the generation and transmission of a location-based reminder regarding a previously transmitted marketing message.

### BACKGROUND OF THE INVENTION

It is known to present marketing messages to potential customers. Unfortunately, the messages do not account for the physical location of the target recipient, which information could provide retailers and/or any business or third person with a further opportunity to determine which offers and/or messages are best suited given such current or expected locations.

Thus, there is a long-felt need to provide a system and a method to intelligently and automatically provide follow-up to previously-sent marketing messages that is location sensitive and optimizes parameters associated with a business entity sending the message while increasing the likelihood of a desired response to the follow-up.

### SUMMARY OF THE INVENTION

The invention broadly comprises a computer-based system for generating and transmitting a location based offer reminder, including: an interface element for at least one specially programmed general-purpose computer; a memory element for the at least one specially programmed general-purpose computer, the memory element storing a record of at least one communication sent to at least one wireless communications device (WCD); and a reminder element, in a processor for the at least one specially programmed general-purpose computer. The reminder element is for: identifying, using the interface element, the at least one WCD as being within a prescribed geographical area; determining that a response to the at least one communication has not been received; generating at least one reminder regarding the at least one communication; and transmitting, using the interface element, the at least one reminder to a wireless communications network for transmission to the at least one WCD.

In a first embodiment, the reminder element is for generating the at least one communication and for transmitting, using the interface element, the at least one communication to the wireless communications network for transmission to the at least one WCD. In a second embodiment, the reminder element is for generating the at least one reminder using at least one of a set of rules or an artificial intelligence program stored in the memory unit. In a third embodiment, the reminder element is for determining, using at least one of a set of rules or an artificial intelligence program stored in the memory unit, the geographical area. In a fourth embodiment, the at least one communication includes a plurality of communications and the reminder element is for: determining that a respective response to more than one communication in the plurality of communications has not been received; determining for which of the more than one communications to generate a respective reminder; generating the respective reminders; and transmitting the respective reminders to the wireless communications network for transmission to the WCD.

In a fifth embodiment, the reminder element is for: using at least one of a first set of rules or a first artificial intelligence program stored in the memory unit to determine for which of the more than one communications to generate a respective reminder; or using at least one of a second set of rules or a second artificial intelligence program stored in the memory unit to generate the respective reminders. In a sixth embodiment, the reminder element is for identifying an order transaction, in the prescribed geographical area, involving the at least one WCD. In a seventh embodiment, the at least one communication is with respect to at least one business location and the reminder element is for determining the geographical area based a position with respect to the at least one business location.

In an eighth embodiment, the at least one business location includes a first plurality of business locations and wherein the reminder element is for: selecting a second plurality of business locations from the first plurality of business locations, the second plurality including less than all of the business locations in the first plurality; generating respective reminders related to the business locations in the second plurality; and, transmitting the respective reminders to the wireless communications network for transmission to the WCD. In one embodiment, the reminder element is for using at least one of a set of rules or an artificial intelligence program stored in the memory unit to select the second plurality of business locations. In a ninth embodiment, the reminder element is for accepting, using the interface element, a search query from the at least one WCD and the at least one communication includes information responsive to the search query. In a tenth embodiment, the at least one WCD includes a plurality of WCDs and the reminder element is for: identifying first and second WCDs from the plurality of WCDs; determining that a respective response has not been received from the first and second WCDs; generating first and second reminders, different one from the other, for the first and second WCDs, respectively; and transmitting the first and second reminders to the wireless communications network for transmission to the first and second WCDs, respectively. In one embodiment, the reminder element is for using at least one of a set of rules or an artificial intelligence program stored in the memory unit to generate the first and second reminders.

The invention also broadly comprises a method for generating and transmitting a location based offer reminder.

It is a general object of the present invention to provide a method and system for the generation and transmission of a location-based reminder regarding a previously transmitted marketing message.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a schematic block diagram of a present invention apparatus for generating and transmitting an order initiation offer to a wireless communications device (WCD);

FIG. 2 is a flow chart of a present invention method for generating and transmitting an order initiation offer to a wireless communications device (WCD);

FIG. 3 is a schematic block diagram of a present invention system for generating and transmitting a location based offer reminder; and,

FIG. 4 is a flow chart of a present invention method for generating and transmitting a location based offer reminder.

### DETAILED DESCRIPTION OF THE PREFERRED EMBODIMENT

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein shall include the same meaning as commonly understood to one of ordinary skill in the art to which this invention belongs. Although any methods, devices or materials similar or equivalent to those described herein can be used in the practice or testing of the invention, the preferred methods, devices, and materials are now described.

It should be understood that the use of “or” in the present application is with respect to a “non-exclusive” arrangement, unless stated otherwise. For example, when saying that “item x is A or B,” it is understood that this can mean one of the following: 1) item x is only one or the other of A and B; and 2) item x is both A and B. Alternately stated, the word “or” is not used to define an “exclusive or” arrangement. For example, an “exclusive or” arrangement for the statement “item x is A or B” would require that x can be only one of A and B.

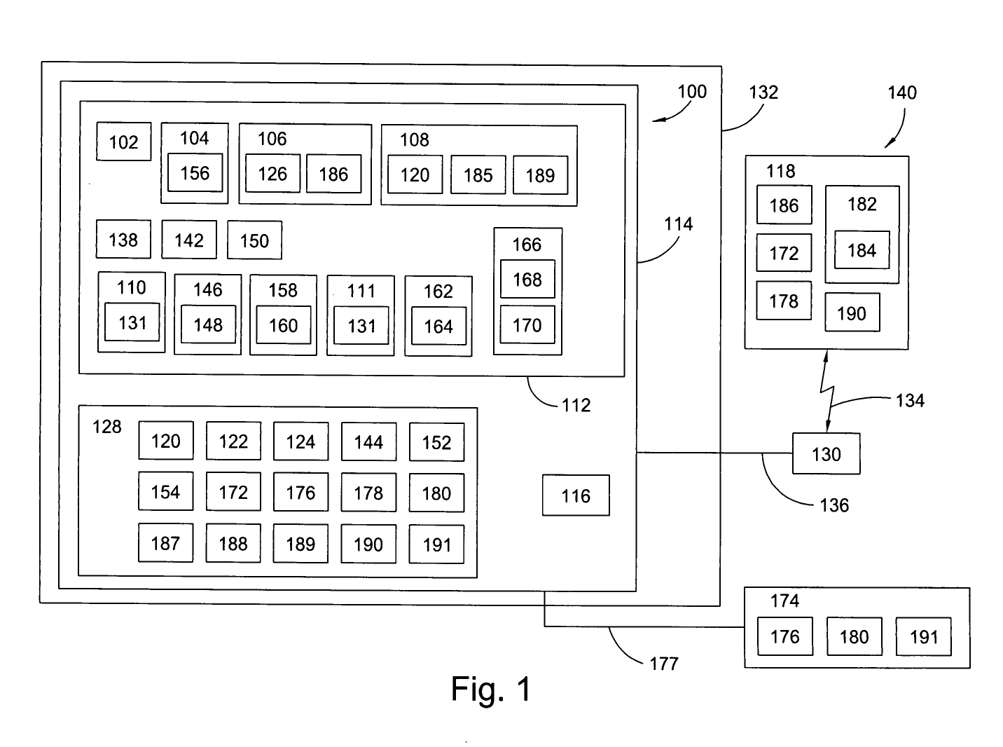

FIG. 1 is a block diagram for present invention system 100 for generating and transmitting an order initiation offer to a wireless communications device (WCD). System 100 includes: identification element 102, eligibility element 104, executable element 106, offer element 108, transceiver element 110, and order initiation element 111, all located in processor 112 of at least one specially programmed general-purpose computer 114. Alternately stated, elements 102, 104, 106, 108, 110, and 111, and any other elements described as being in the processor are functions of the processor or are functions carried out by the processor.

Element 102 identifies, using interface element 116, WCD 118. The eligibility element determines if the WCD is eligible to receive order initiation offer 120. Offer 120 is an offer that is made that when accepted (further described below) initiates a transaction. The executable element is arranged to generate, using one or both of rules 122 and artificial intelligence program 124, at least one executable 126. The set of rules and the artificial intelligence program are stored in memory unit 128. In one embodiment, the executable is generated as disclosed by commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007.

In one embodiment, computer 114 receives at least one modifying rule 172 from a WCD and stores the rule in memory 128. In another embodiment, the WCD is WCD 118. The executable element modifies executable 126 using rule 172. The WCD generates rule 172, and the executable element modifies executable 126 as described in U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed May 2, 2008.

In one embodiment, computer 174, separate from computer 114, transmits modifying rule 176 to computer 114. Computer 174 can be in location 132 (not shown) or can be in a different location. Computer 174 can be associated with a business entity associated with location 132 or can be associated with a different business entity. Connection 177 between computers 114 and 342 is any type known in the art. In another embodiment (not shown), multiple computers 174 are included and respective computers among the multiple computers can be associated with the same or different business entities. Computer 114 stores modifying rule 176 in memory 128. Element 106 modifies executable 126 using rule 176. Computer 174 generates rule 176, and element 106 modifies executable 126, respectively, as described in U.S. Patent Application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed May 2, 2008.

The executable is directed toward determining an offer that is most acceptable to an end user of the WCD and best meets prescribed criteria of the entity making the offer. For example, acceptability could be based on price, free items, or other criteria mentioned below. Rules 122 or program 124 are used to find the appropriate combination of acceptability and entity criteria.

The offer element generates, for an eligible WCD and using the at least one executable, an appropriate order initiation offer 120. In general, the core of offer 120 is shaped by, determined by, or consists of executable 126. The transceiver element transmits, using the interface element, the appropriate order initiation offer 120 to wireless communications network 130 for transmission to the WCD. The transceiver element also is arranged to receive, via the interface element, response 131, including an order, from the WCD. Element 111 initiates fulfillment of the order by any means known in the art.

By interface element, we mean any combination of hardware, firmware, or software in a computer used to enable communication or data transfer between the computer and a device, system, or network external to the computer. The interface element can connect with the device, system, or network external to the computer, for example, network 130, using any means known in the art, including, but not limited to a hardwire connection, an optical connection, an Internet connection, or a radio frequency connection. Processor 112 and interface element 116 can be any processor or interface element, respectively, or combination thereof, known in the art.

Computer 114 can be any computer or plurality of computers known in the art. In one embodiment, the computer is located in a retail location with which system 100 is associated, for example, location 132. In another embodiment (not shown), all or parts of the computer are remote from retail locations with which system 100 is associated. In a further embodiment, computer 114 is associated with a plurality of retail locations with which system 100 is associated. Thus, the computer provides the functionality described for more than one retail location. In one embodiment, offer 120 is for an item, good, or service provided by the entity associate with location 132.

A WCD is defined supra. WCD 118 can be any WCD known in the art. In one embodiment, WCD 118 is owned by, leased by, or otherwise already in possession of the end user when system 100 interfaces with the WCD. In the description that follows, it is assumed that the WCD is owned by, leased by, or otherwise already in possession of the end user when system 100 interfaces with the WCD. In general, the WCD communicates with a network, for example, network 130, via radio-frequency connection 134. Network 130 can be any network known in the art. In one embodiment, the network is located outside of the retail location, for example, the network is a commercial cellular telephone network. In one embodiment (not shown), the network is located in a retail location, for example, the network is a local network, such as a Bluetooth network. The interface element can connect with network 130 using any means known in the art, including, but not limited to a hardwire connection, an optical connection, an Internet connection, or a radio frequency connection. In the figures, a non-limiting example of a hardwire connection 136 is shown. In one embodiment, device 118 is connectable to a docking station (not shown) to further enable communication between device 118 and system 100. Any docking station or docking means known in the art can be used. That is, when the device is connected to the docking station, a link is established between the device and system 100.

In a first embodiment, system 100 includes location element 138 in the processor, which determines, using the interface element, location 140 for the WCD. The location of the WCD can be determined using any means known in the art, including, but not limited to, GPS technology and information from network 130. Then, the eligibility element determines eligibility in response to location 140, the executable element generates the at least one executable responsive to location 140, or the offer element generates an appropriate order initiation offer responsive to location 140. It should be understood that any combination of the eligibility, executable, and offer elements can operate responsive to location 140. Any criteria known in the art can be used to control the operation of the eligibility, executable, and offer elements responsive to location 140. For example, the elements can operate when the WCD is within a certain specified distance from one or more retail locations, for example, location 132; the elements can operate to generate offer 120 for a specific retail location according to location 140; or the elements can operate to generate offer 120 offering options with respect to a plurality of retail locations (not shown) based on respective distances of the WCD from the plurality of locations.

In a second embodiment, system 100 includes transaction element 142 that accesses transaction history 144, stored in the memory unit, for the WCD or an end user (not shown) associated with the WCD. In one embodiment, the history is stored in a separate computer system (not shown) accessed by system 100. The eligibility element determines eligibility in response to history 144, the executable element generates the at least one executable responsive to history 144, or the offer element generates an appropriate order initiation offer responsive to history 144. It should be understood that any combination of the eligibility, executable, and offer elements can operate responsive to history 144.

Any criteria known in the art can be used to control the operation of the eligibility, executable, and offer elements responsive to history 144. For example, executable 126 can be generated in response to trends noted in the history. The executable can be directed to a continuation of the trend or can derive variants from the trend that may be acceptable to the end user and in the interest of the retail location. Further, the continuation or variants can be aligned with parameters defined for the retail location. For example, the executable can be addressed to a desired promotion, conditions at the retail location, such as stock on hand, or attempts to increase a total bill for the end user.

In another embodiment, history 144 includes searches made using the WCD or communications by the WCD. Alternately stated, system 100 is linked to search browsers associated with the WCD. Any type of search or WCD communication known in the art can be included in history 144. For example, if the WCD has been used to search for products typically available at a retail location similar to location 132, the offer element generates offers for transmission to the WCD when the WCD is within a specified location of such a retail location, for example, location 132. As another example, the communications can be, but are not limited to, telephone calls or email messages to a specific retail location or to a category of retail locations. As another example, if history 144 shows that the WCD has communicated with location 132, eligibility or the offer can be tailored in response to this information.

In a third embodiment, the eligibility element determines eligibility in response to a time of day, in general, the time of day when the WCD is identified, the executable element generates the at least one executable responsive to the time of day, or the offer element generates an appropriate order initiation offer responsive to the time of day. It should be understood that any combination of the eligibility, executable, and offer elements can operate responsive to the time of day. Any criteria known in the art can be used to control the operation of the eligibility, executable, and offer elements responsive to the time of day. For example, executable 126 can be generated in response to trends for an end user with respect to the time of day or with parameters for the retail location associated with the time of day. The executable can be directed to a continuation of the trend or can derive variants from the trend that may be acceptable to the end user. Further, the continuation or variants can be aligned with parameters defined for the retail location. For example, the executable can be addressed to a desired promotion, conditions at the retail location, such as stock on hand, or attempts to increase a total bill for the end user.

In a fourth embodiment, the eligibility element determines eligibility in response to the day of the week, the executable element generates the at least one executable responsive to the day of the week, or wherein the offer element generates an appropriate order initiation offer responsive to the day of the week. It should be understood that any combination of the eligibility, executable, and offer elements can operate responsive to the day of the week. Any criteria known in the art can be used to control the operation of the eligibility, executable, and offer elements responsive to the day of the week. For example, executable 126 can be generated in response to trends for an end user with respect to the day of the week or with parameters for the retail location associated with the day. In general, this embodiment operates similar to the embodiment directed to the time of day.

In a fifth embodiment, system 100 includes volume element 146, in the processor, which determines transaction volume 148 for at least one retail location, for example, location 132. Element 146 can use any means known in the art to determine volume 148. In one embodiment, element 146 interfaces with another computer system (not shown) associated with location 132 to determine or obtain volume 148. The eligibility element determines eligibility in response to volume 148, the executable element generates the at least one executable responsive to volume 148, or the offer element generates an appropriate order initiation offer responsive to volume 148. It should be understood that any combination of the eligibility, executable, and offer elements can operate responsive to volume 148. Any criteria known in the art can be used to control the operation of the eligibility, executable, and offer elements responsive to volume 148. For example, executable 126 can be generated to create offers that are higher profit (may be less acceptable to an end user) if the volume is high or can generate lower profit (more acceptable offers) if the volume is low. Also, executable 126 can be refined to address respective volume data for various products or groups of products, rather than overall volume.

In a sixth embodiment, system 100 includes order element 150, in the processor, which determine whether an order (not shown) has been placed previously using the WCD. In one embodiment, element 150 interfaces with another computer system (not shown) associated with location 132 to determine or obtain information regarding a previous order. Then, the eligibility element determines eligibility in response to whether an order has been placed previously using the WCD, the executable element generates the at least one executable responsive to whether an order has been placed previously using the WCD, or the offer element generates an appropriate order initiation offer responsive to whether an order has been placed previously using the WCD. It should be understood that any combination of the eligibility, executable, and offer elements can operate responsive to whether an order has been placed previously using the WCD. Any criteria known in the art can be used to control the operation of the eligibility, executable, and offer elements responsive to whether an order has been placed previously using the WCD. For example, executable 126 can be generated to present more acceptable (perhaps lower profit) offers to first time orders from the WCD or can present more acceptable offers to reward continued use of the WCD to place orders.

In a seventh embodiment, element 150 determines whether an order has been placed previously using the WCD during a specified time of day or a specified day of the week. Then, the eligibility element determines eligibility in response to whether an order has been placed previously using the WCD during a specified time of day or a specified day of the week, the executable element generates the at least one executable responsive to whether an order has been placed previously using the WCD during a specified time of day or a specified day of the week, or the offer element generates an appropriate order initiation offer responsive to whether an order has been placed previously using the WCD during a specified time of day or a specified day of the week. It should be understood that any combination of the eligibility, executable, and offer elements can operate responsive to whether an order has been placed previously using the WCD during a specified time of day or a specified day of the week. Any criteria known in the art can be used to control the operation of the eligibility, executable, and offer elements responsive to whether an order has been placed previously using the WCD during a specified time of day or a specified day of the week. This embodiment is a refinement of the previous embodiment. For example, additional temporal criteria are added to the generation of the executable.

In an eighth embodiment, the eligibility element generates, using at least one of set of rules 152 and artificial intelligence program 154, at least one executable 156. Set of rules 152 and artificial intelligence program 154 are stored in the memory unit. The eligibility element is arranged to determine if the WCD is eligible to receive an order initiation using executable 156. In one embodiment, executable 156 is generated as disclosed by commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007.

In one embodiment, computer 114 receives at least one modifying rule 178 from a WCD and stores the rule in memory 128. In another embodiment, the WCD is WCD 118. Element 104 modifies executable 156 using rule 178. The WCD generates rule 178 and element 104 modifies executable 156 as described in U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed May 2, 2008.

In one embodiment, computer 174 transmits at least one modifying rule 180 to computer 114. Computer 114 stores modifying rule 180 in memory 128. Element 104 modifies executable 156, using rule 180. Computer 174 generates rule 180, and element 104 modifies executable 156, respectively, as described in U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed May 2, 2008.

In one embodiment, the eligibility element determines if an end user associated with the WCD is eligible for the order initiation offer. That is, the criteria with respect to eligibility are with respect to an end user of the WCD. In another embodiment, system 100 includes receiving element 158, in the processor, arranged to receive, using the interface element, transmission 160 from the WCD via the communication network. The identification element identifies the WCD in response to the transmission, using any means known in the art. That is, rather than system 100 contacting the WCD to initiate the operations noted above, system 100 initiates the operations after being contacted by the WCD.

In a further embodiment, system 100 includes inventory element 162, in the processor, which obtains inventory information 164. In general, information 164 related to inventory availability, for example, an inventory of product or services in stock or ready for purchase at the retail location. For example, in a restaurant, information 164 might be regarding the number and type of already-prepared breakfast items at the restaurant. In a location selling durable goods, such as appliances, the information could be regarding whether various of the durable goods are in stock at the retail location. In yet another embodiment, element 162 interfaces with another system, for example, a local or centralized computer system associated with operations at the retail location, to obtain information 164, or to obtain data to determine information 164. In a still further embodiment, element 162 compiles the data necessary to determine information 164. For example, operations at the retail location are processed by computer 114. The eligibility element determines eligibility in response to inventory information, for example, if there is a surplus of items on hand, the requirements for eligibility can be loosened, the executable element generates the at least one executable responsive to inventory information, or the offer element generates an appropriate order initiation offer responsive to inventory information, for example, if the supply of items on hand is low, offers for that item can be made more profitable for the retail location.

In one embodiment, system 100 includes registration element 166, in the processor, which communicates with the WCD through the transceiver element. Element 166 transmits information 168 regarding registration of a WCD with system 100, for example, soliciting registration, providing instructions for registering, and promoting registration. Element 166 also receives registration information 170 for the WCD.

In one embodiment, memory element 182 in WCD 118 stores at least one rule 184. Processor 186 in the WCD implements offer 120 according to rule 184. The WCD generates rule 184, and operates on offer 120 as described in U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed May 2, 2008.

In one embodiment the offer element determines redemption rate 185 for offer 126. The executable element generates at least one executable 186, using the redemption rate, and at least one of set of rules 187 or artificial intelligence program 188 stored in memory unit 128. The offer element generates appropriate order initiation offer 189 using executable 186, and the transmission element transmits, using the interface element, offer 189 to the wireless communications network for transmission to the WCD.

In another embodiment, the offer element modifies, using the redemption rate, rules 122 or artificial intelligence program 124 to create rules 187 or artificial intelligence program 188, respectively.

In a further embodiment, offers 120 and 189 are transmitted to the WCD regardless of the location of the WCD with respect to a business location, for example, location 132, and stored in memory 182. The location element determines, using the interface element, when the WCD is within a specified distance (not shown) of the business location and retrieves, using the interface element, offer 120 or 189 from memory 182 for presentation, for example, on a point of sale station for the business location. In another embodiment, offers 120 and 189 are stored in memory 128 until the location element, using the interface element, identifies the WCD as being within a specified distance (not shown) of the business location, at which time offers 120 and 189 are transmitted to the WCD.

In one embodiment, computer 114 receives at least one modifying rule 190 from a WCD and stores the rule in memory 128. In another embodiment, the WCD is WCD 118. Element 106 modifies executable 186 using rule 190. The WCD generates rule 190 and element 106 modifies executable 186 as described in U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed May 2, 2008.

In one embodiment, computer 174 transmits at least one modifying rule 191 to computer 114. Computer 114 stores modifying rule 191 in memory 128. Element 106 modifies executable 186, using rule 191. Computer 174 generates rule 191, and element 106 modifies executable 186, respectively, as described in U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed May 2, 2008.

It should be understood that various storage and removal operations, not explicitly described above, involving memory 128 and as known in the art, are possible with respect to the operation of system 100. For example, outputs from and inputs to the general-purpose computer can be stored and retrieved from the memory elements and data generated by the processor can be stored in and retrieved from the memory.

It should be understood that the locating element can determine the distance of the WCD from more than one business, or retail, location. It also should be understood that the offer element can generate and transmit more than one offer for a business location and can generate respective offers for more than one business location or entity. It also should be understood that a plurality of distance and offer criteria and metrics can be used by the location and offer elements to determine a distance to use and to generate an offer, respectively. The criteria and metrics can include, but are not limited to, information specific to operations at a particular business entity or business location, geographical information, and temporal aspects, such as time of day.

It should be understood that system 100 can be operated by the same business entity operating or owning a business location using the system, or can be operated by a third party different than the business entity operating or owning the business location using the system. In one embodiment, a third party operates system 100 as disclosed by commonly-owned U.S. patent application Ser. No. 11/985,141: “UPSELL SYSTEM EMBEDDED IN A SYSTEM AND CONTROLLED BY A THIRD PARTY,” inventors Otto et al., filed Nov. 13, 2007.

It should be understood that system 100 can be integral with a computer operating system for a business location, for example, location 132 or with a business entity operating the business location. It also should be understood that system 100 can be wholly or partly separate from the computer operating system for a retail location, for example, location 132, or with a business entity operating the business location.

It should be understood that although individual rule sets and artificial intelligence programs are discussed, the individual rule sets and AI programs can be combined into composite rules sets or artificial intelligence programs. Any combination of individual rule sets or artificial intelligence programs is included in the spirit and scope of the claimed invention. For example, rules 122 and 152 can be a single set of rules (not shown) or artificial intelligence programs 124 and 154 can be a single program (not shown).

It should be understood that the examples above regarding executables are non-limiting, are meant to provide only a broad overview, and do not address the number, complexity, structure, or interrelationships of the operations included in the actual generation of the executables.

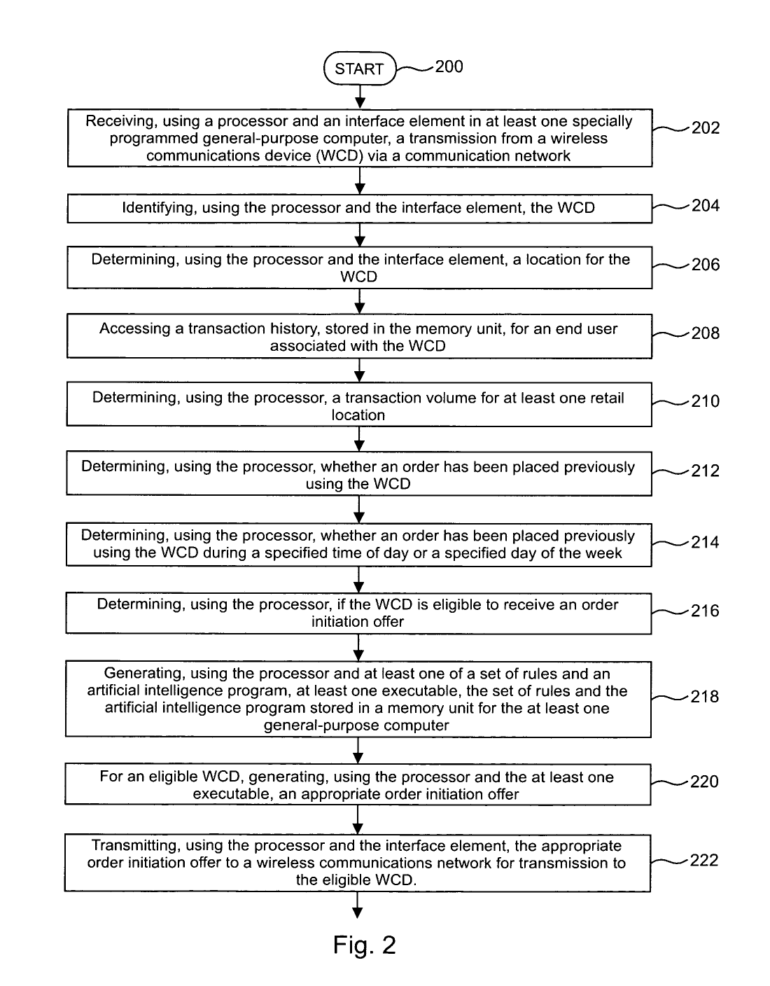

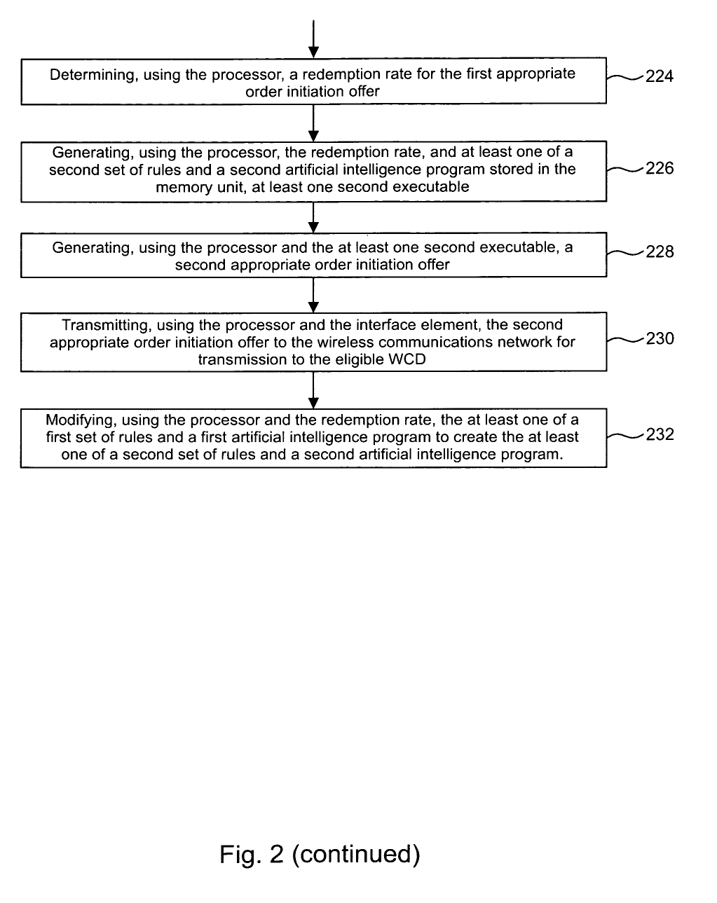

FIG. 2 is a flow chart illustrating a present invention computer-based method for generating and transmitting an order initiation offer to a wireless communications device (WCD). Although the method in FIG. 2 is depicted as a sequence of numbered steps for clarity, no order should be inferred from the numbering unless explicitly stated. The method starts at Step 200. Step 204 identifies, using a processor and an interface element in at least one specially programmed general-purpose computer, a WCD. Step 216 determines, using the processor, if the WCD is eligible to receive an order initiation offer. Step 218 generates, using the processor and at least one of a set of rules or an artificial intelligence program, at least one executable, the set of rules and the artificial intelligence program stored in a memory unit for the at least one general-purpose computer. Step 220, for an eligible WCD, generates, using the processor and the at least one executable, an appropriate order initiation offer. Step 222 transmits, using the processor and the interface element, the appropriate order initiation offer to a wireless communications network for transmission to the eligible WCD.

In a first embodiment, step 206 determines, using the processor and the interface element, a location for the WCD and determining if the WCD is eligible to receive an order initiation offer includes determining in response to the location, generating at least one executable includes generating the at least one executable responsive to the location, or generating an appropriate order initiation offer includes generating the appropriate order initiation offer responsive to the location.

In a second embodiment, step 208 accesses a transaction history, stored in the memory unit, for an end user associated with the WCD and determining if the WCD is eligible to receive an order initiation offer includes determining in response to the transaction history, and generating at least one executable includes generating the at least one executable responsive to the transaction history, or generating an appropriate order initiation offer includes generating the appropriate order initiation offer responsive to the transaction history. In one embodiment, the history includes searches made using the WCD or communications by the WCD. Alternately stated, the method links to search browsers associated with the WCD. Any type of search or WCD communication known in the art can be included in the history. For example, if the WCD has been used to search for products typically available at a retail location similar to the retail location, step 220 generates offers for transmission to the WCD when the WCD is within a specified location of such a retail location. As another example, the communications can be, but are not limited to, telephone calls or email messages to a specific retail location or to a category of retail locations. As another example, if the history shows that the WCD has communicated with the retail location, then steps 216 or 220 can be tailored in response to this information.

In a third embodiment, step 210 determines, using the processor, a transaction volume for at least one retail location and determining if the WCD is eligible to receive an order initiation offer includes determining in response to the transaction volume, and generating at least one executable includes generating the at least one executable responsive to the transaction volume, or generating an appropriate order initiation offer includes generating the appropriate order initiation offer responsive to the transaction volume.

In a fourth embodiment, step 212 determines, using the processor, whether an order has been placed previously using the WCD and determining if the WCD is eligible to receive an order initiation offer includes determining in response to whether an order has been placed previously using the WCD, and generating at least one executable includes generating the at least one executable responsive to whether an order has been placed previously using the WCD, or generating an appropriate order initiation offer includes generating the appropriate order initiation offer responsive to whether an order has been placed previously using the WCD.

In a fifth embodiment, step 214 determines, using the processor, whether an order has been placed previously using the WCD during a specified time of day or a specified day of the week and determining if the WCD is eligible to receive an order initiation offer includes determining in response to whether an order has been placed previously using the WCD during the specified time of day or the specified day of the week, and generating at least one executable includes generating the at least one executable responsive to whether an order has been placed previously using the WCD during the specified time of day or the specified day of the week, or generating an appropriate order initiation offer includes generating the appropriate order initiation offer responsive to whether an order has been placed previously using the WCD during the specified time of day or the specified day of the week.

In a sixth embodiment, step 216 obtains, using the processor, inventory information and determining if the WCD is eligible to receive an order initiation offer includes determining in response to the inventory information, and generating at least one executable includes generating the at least one executable responsive to the inventory information, or generating an appropriate order initiation offer includes generating the appropriate order initiation offer responsive to the inventory information.

In a seventh embodiment, step 224 determines, using the processor, a redemption rate for the first appropriate order initiation offer; step 226 generates, using the processor, the redemption rate, and at least one of a second set of rules and a second artificial intelligence program stored in the memory unit, at least one second executable; step 228 generates, using the processor and the at least one second executable, a second appropriate order initiation offer; and step 230 transmits, using the processor and the interface element, the second appropriate order initiation offer to the wireless communications network for transmission to the eligible WCD. In an eighth embodiment, step 232 modifies, using the processor and the redemption rate, the at least one of a first set of rules and a first artificial intelligence program to create the at least one of a second set of rules and a second artificial intelligence program.

In a ninth embodiment, determining, using the processor, if the WCD is eligible to receive an order initiation offer includes using at least one of the set of rules or the artificial intelligence program. In a tenth embodiment, determining if the WCD is eligible to receive an order initiation offer includes determining if an end user associated with the WCD is eligible for the order initiation offer. In an eleventh embodiment, determining if the WCD is eligible to receive an order initiation offer includes determining eligibility in response to the time of day, generating at least one executable includes generating the at least one executable responsive to the time of day, or generating an appropriate order initiation offer includes generating the appropriate order initiation offer responsive to the time of day. In a twelfth embodiment, determining if the WCD is eligible to receive an order initiation offer includes determining in response to a day of the week, generating at least one executable includes generating the at least one executable responsive to the day of the week, or generating an appropriate order initiation offer includes generating the appropriate order initiation offer responsive to the day of the week.

In a thirteenth embodiment, step 202 receives, using the processor and the interface element, a transmission from the WCD via the communication network and identifying a WCD includes identifying the WCD in response to the transmission.

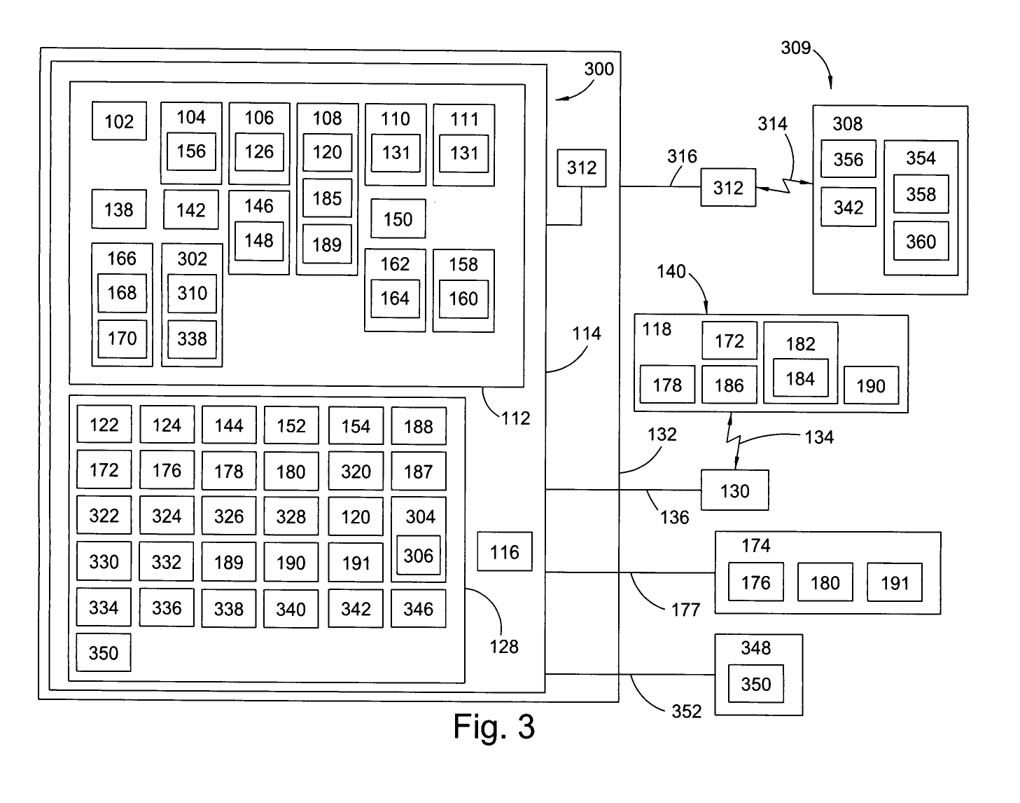

FIG. 3 is a schematic block diagram of present invention system 300 for generating and transmitting a location based offer reminder. The system includes reminder element 302 in processor 112 and record 304 of at least one communication 306 sent to at least one wireless communications device (WCD) 308. Record 304 can include one or a multiplicity of communications 306. The reminder element is arranged to, that is, the reminder element is for: identifying, using the interface element, the at least one WCD as being within a prescribed geographical area 309; determining that a response to the at least one communication has not been received; generating at least one reminder 310 regarding the at least one communication; and transmitting, using the interface element, the at least one reminder to wireless communications network 312 for transmission to the at least one WCD. Alternately stated, element 302 and any other elements described as being in the processor are functions of the processor or are functions carried out by the processor. As described infra, the system can selectively operate on a multiplicity of communications, for example, generate and transmit respective reminders for selected communications.

A WCD is defined supra. WCD 308 can be any WCD known in the art. In general, the discussion of WCD 118, network 130, and connections 134 and 136, supra, are applicable to WCD 308, network 312, and connections 314 and 316. Although only one WCD 308 is shown in the figures, it should be understood that more than one WCD can receive reminders from system 300. It also should be understood than different types of WCDs can be among a plurality of WCDs receiving reminders.

In a first embodiment, the reminder element generates the communication and transmits, using the interface element, the communication to the wireless communications network for transmission to the at least one WCD. Responses to the communication from the WCD are monitored by the reminder element via the interface element. That is, system 300 generates the communication and a response to which is monitored by the system. The general purpose of the reminder is to urge or motivate an end user of the WCD to respond to communication 306. In one embodiment, the communication is a promotional offer, for example, a coupon, for a retail location, for example, location 132. The reminder is to motivate or remind the end user to redeem the offer. In another embodiment, the reminder does not include an incentive. In a further embodiment, the reminder includes any type of incentive known in the art, for example, an offer to discount the price for an item included in the promotional offer. Although only a single location is shown in the figures, it should be understood that more than one location can be associated with communications, reminders, or a geographical area.

In a second embodiment, generating at least one reminder includes using at least one of set of rules 318 or artificial intelligence program 320 stored in the memory unit. The discussion of the generation of executables as disclosed by commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007 is applicable to generating the reminder.

In general, the use of rules 318 or artificial intelligence program 320 (and any other rules or artificial intelligence programs discussed infra) is directed to generating and transmitting reminders optimizing the attainment of one or more goals established by a business entity owning a business using the system, for example, a business entity owning location 132, or optimizing one or more parameters associated with operations of the business entity. For example, generating and transmitting a reminder, or performing the other operations described herein associated with rules or artificial intelligence programs, includes making a selection of one or more choices from among two or more choices that yields the best or optimized outcome or yields. Optimization or maximization can be with respect to revenues, profits, item counts, average check, market basket contents, marketing offer acceptance, store visitation or other frequency measures, or improving or optimizing speed of service inventory levels, turns, yield, waste, enhancing or optimizing customer loyalty or use of kiosks or internet or other POS devices or self service devices, use of coupons or acceptance of marketing offers, reduction or optimization of any customer or cashier or any other person's gaming, fishing, or any other undesirable action or activities or failures to act when desired, minimizing or optimizing any dilution or diversion of sales, profits, average check, minimizing or optimizing use of discounts and other promotions so as to maximize or optimize any of the foregoing desired actions, outcomes or other desired benefits, or any combination of minimizing undesired results while maximizing or optimizing any one or more of any desired results.

In a third embodiment, the at least one communication includes a plurality of communications. The offer element determines that a respective response to more than one communication in the plurality of communications has not been received, determines for which of the more than one communications to generate a respective reminder, and generates the respective reminders. The offer element also determines which of the respective reminders to transmit and transmits the determined respective reminders. That is, communication 306 includes multiple communications, for example, multiple offers. The communications can be to one WCD associated with a customer or with a plurality of WCDs associated with the customer. Each WCD can receive all the communications, or various or the WCDs can receive only some of the communications. The reminder element determines that at least two of the communications have not been responded to, and in response, exercises several levels of decision. First, the reminder element determines if a reminder is to be sent for all or only some of the communications in the plurality. For example, there may be parameters and metrics, for example, time of day, that indicate that a reminder to some of the communications may be more fruitful than reminders to other of the communications. Then, the reminder element determines the content of the respective reminders. Any criteria known in the art can be used to select which communications are to receive reminders and to create the content of the selected reminders.

In one embodiment, the reminder element uses at least one of set of rules 322 or artificial intelligence program 324 stored in the memory unit to determine for which of the more than one communications to generate a respective reminder. In another embodiment, the reminder element uses at least one of set of rules 326 or artificial intelligence program 328 stored in the memory unit to generate the respective reminders. The discussion of the generation of executables as disclosed by commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007 is applicable to rules 322 and 326 and programs 324 and 328.

In a fourth embodiment, any means known in the art, for example, as described in commonly-owned U.S. patent application titled: “METHOD AND APPARATUS FOR GENERATING AND TRANSMITTING AN ORDER INITIATION OFFER TO A WIRELESS COMMUNICATIONS DEVICE,” inventors Otto et al., filed May 2, 2008 is used to identify the WCD. In a fifth embodiment, identifying the at least one WCD as being within a prescribed geographical area includes identifying an order transaction, in the prescribed geographical area, involving the at least one WCD. For example, WCD 308 transmits an order to location 132 and system 300 determines that the WCD is within the geographical area based upon the receipt of the order.

In a sixth embodiment, the communication is with respect to a business location, for example, location 132, and the reminder element determines the geographical area based a position of the WCD with respect to the business location. For example, the reminder element determines if the WCD is within a specified distance from the location. In one embodiment, the communication is with respect to multiple business locations (not shown) and the reminder element determines the geographical area based on the position of the WCD with respect to the multiple locations. In one embodiment, the various locations are “weighted” so that the respective distances of the WCD from the locations may not be the same. Any weighting factor known in the art can be used. For example, an area could be defined as the WCD being within one mile or less of one location and within one half mile or less of another location. As another example, a business entity associated with one of the respective locations could pay a premium to an administrator of system 300 to manipulate the bounds of the geographical area to increases the inclusion of their location while minimizing the inclusion of competitor's locations.

In one embodiment, determining the geographical area based a position of the WCD with respect to one business location or a plurality of business locations includes using at least one of set of rules 330 or artificial intelligence program 332 stored in the memory unit. The discussion of the generation of executables as disclosed by commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007 is applicable to using at least one of set of rules 330 or artificial intelligence program 332.

In a seventh embodiment, the at least one business location includes a first plurality of business locations (not shown) and the reminder element selects a second plurality of business locations from the first plurality of business locations. The second plurality includes less than all of the business locations in the first plurality. That is, system 300 exercises a level of control over which eligible business location are to be included in the operation of the system. The reminder element generates respective reminders related to the business locations in the second plurality and transmits the respective reminders to the business. Any selecting criteria known in the art can be used. For example, given the types of locations in the first plurality and given a transaction history for an end user of the WCD, locations with the highest probability of eliciting a positive response to respective reminders are included in the second plurality.

In one embodiment, selecting a second plurality of business locations includes using at least one of set of rules 334 or artificial intelligence program 336 stored in the memory unit. The discussion of the generation of executables as disclosed by commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007 is applicable to using at least one of set of rules 334 or artificial intelligence program 336.

In an eighth embodiment, the reminder element accepts, using the interface element, search query 338 from the at least one WCD and the at least one communication includes information responsive to the search query. For example, the search query is transmitted by the WCD and stored in the memory element until the WCD is detected as being in the geographical area as described supra. For example, an end user of the WCD could enter the search “santa fe book store” into a search engine on the WCD. A list of ad listings for bookstores is generated on the device. When the device is discovered to be in the geographic location, for example, within a mile of one of the bookstores in the list, a reminder regarding the applicable ad listing from the list of ad listings is included in the reminder.

In a ninth embodiment, the at least one WCD includes a plurality of WCDs (not shown) and the reminder element identifies more than one of the WCDs in the plurality of WCDs are being in the geographical area, for example, first and second WCDs from the plurality of WCDs. Element 302 also determines that a respective response has not been received from the more than one of the WCDs, for example, the first and second WCDs and generates respective reminders (not shown), different one from the other, for the respective WCDs, for example, reminders for the first and second WCDs, respectively. The reminder element then transmits the respective reminders to the appropriate WCDs. In this manner, system 300 can adapt reminders to the type of WCD identified in the geographical area. For example, the respective reminders can be generated to optimize responses based on respective transaction histories associated with the WCDs and the particular goals and criteria of the location(s) associated with the geographical area.

In one embodiment, generating the respective reminders includes using at least one of set of rules 340 or artificial intelligence program 342 stored in the memory unit. The discussion of the generation of executables as disclosed by commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007 is applicable to using at least one of set of rules 338 or artificial intelligence program 340.

In a tenth embodiment, computer 114 receives at least one modifying rule 346 from a WCD, for example, WCD 308 and stores the rule in memory 128. Element 302 modifies reminder 310 using rule 346. The WCD generates rule 346 and element 302 modifies reminder 310 as described in commonly-owned U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed May 2, 2008.

In an eleventh embodiment, computer 348 transmits at least one modifying rule 350 to computer 114. Computer 114 stores modifying rule 30 in memory 128. Element 302 modifies reminder 310 using rule 350. Computer 348 generates rule 350, and element 302 modifies reminder 310 using rule 350 as described in commonly-owned U.S. Patent Application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed May 2, 2008. In one embodiment (not shown), multiple computers 348 are included and respective computers among the multiple computers can be associated with the same or different business entities. Computer 348 is connected to computer 114 by any means known in the art, for example, hardwire connection 352.

In a twelfth embodiment, a WCD, for example, WCD 308, includes memory element 354 and processor 356. WCD 308 stores at least one rule 358 in the memory element and processor 356 executes reminder 310 according to rule 358. The discussion, in the description of FIG. 1, of WCD 118 and rule 184 is applicable to WCD 308 and rule 358, respectively. For example, the WCD generates rule 358, and operates on reminder 310 as described in commonly-owned U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed May 2, 2008. In one embodiment, artificial intelligence program 360 is stored in memory 354 and WCD 308 executes reminder 310 using program 360. In another embodiment, WCD 308 executes reminder 310 using program 360 and rule 358.

It should be understood that various storage and removal operations, not explicitly described above, involving memory 128 and as known in the art, are possible with respect to the operation of system 300. For example, outputs from and inputs to the general-purpose computer can be stored and retrieved from the memory elements and data generated by the processor can be stored in and retrieved from the memory.

It should be understood that system 300 can be operated by the same business entity operating or owning a business location using the system, or can be operated by a third party different than the business entity operating or owning the business location using the system. In one embodiment, a third party operates system 300 as disclosed by commonly-owned U.S. patent application Ser. No. 11/985,141: “UPSELL SYSTEM EMBEDDED IN A SYSTEM AND CONTROLLED BY A THIRD PARTY,” inventors Otto et al., filed Nov. 13, 2007.

It should be understood that system 300 can be integral with a computer operating system for a business location, for example, location 132 or with a business entity operating the business location. It also should be understood that system 300 can be wholly or partly separate from the computer operating system for a retail location, for example, location 132, or with a business entity operating the business location.

It should be understood that although individual rule sets and artificial intelligence programs are discussed, the individual rule sets and AI programs can be combined into composite rules sets or artificial intelligence programs. Any combination of individual rule sets or artificial intelligence programs is included in the spirit and scope of the claimed invention. For example, rules 318 and 322 or programs 320 and 324 can be a single set of rules or program, respectively (not shown).

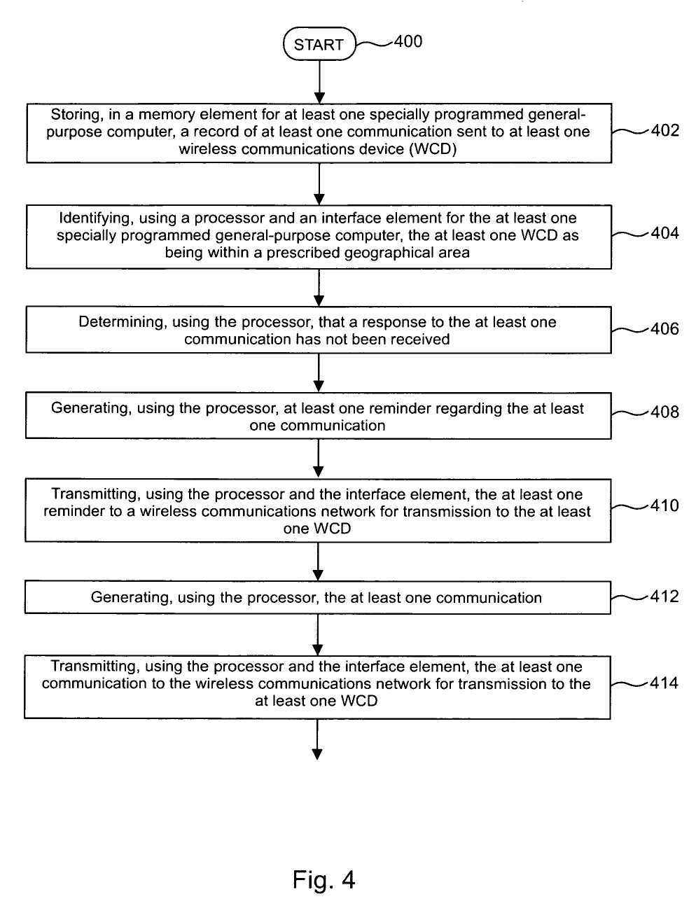

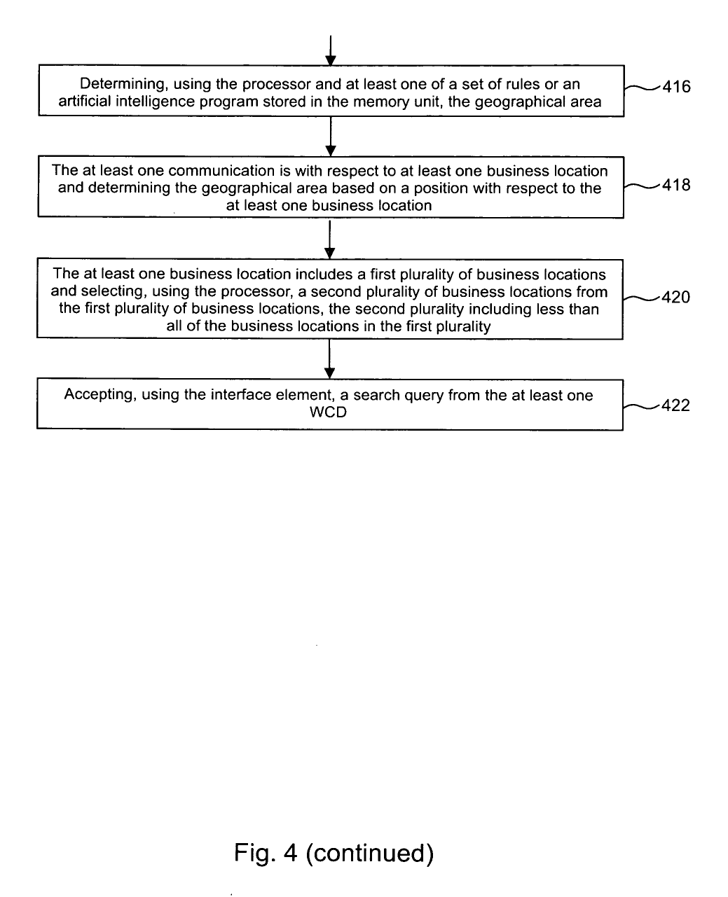

FIG. 4 is a flow chart illustrating a present invention computer-based method for method for generating and transmitting a location based offer reminder. Although the method in FIG. 4 is depicted as a sequence of numbered steps for clarity, no order should be inferred from the numbering unless explicitly stated. The method starts at Step 400. Step 402 stores, in a memory element for at least one specially programmed general-purpose computer, a record of at least one communication sent to at least one wireless communications device (WCD); step 404 identifies, using a processor and an interface element for the at least one specially programmed general-purpose computer, the at least one WCD as being within a prescribed geographical area; step 406 determines, using the processor, that a response to the at least one communication has not been received; step 408 generates, using the processor, at least one reminder regarding the at least one communication; and step 410 transmits, using the processor and the interface element, the at least one reminder to a wireless communications network for transmission to the at least one WCD.

In a first embodiment, step 412 generates, using the processor, the at least one communication; and step 414 transmits, using the processor and the interface element, the at least one communication to the wireless communications network for transmission to the at least one WCD. In one embodiment, generating at least one reminder includes using at least one of a set of rules or an artificial intelligence program stored in the memory unit. In a second embodiment, step 416 determines, using the processor and at least one of a set of rules or an artificial intelligence program stored in the memory unit, the geographical area. In a third embodiment, the at least one communication includes a plurality of communications, determining that a response to the at least one communication has not been received includes determining that a respective response to more than one communication in the plurality of communications has not been received, generating at least one reminder regarding the at least one communication includes determining for which of the more than one communications to generate a respective reminder, and generating the respective reminders; and transmitting the at least one reminder includes transmitting the determined respective reminders.

In a fourth embodiment, determining for which of the more than one communications to generate a respective reminder includes using at least one of a first set of rules or a first artificial intelligence program stored in the memory unit or wherein generating the respective reminders includes using at least one of a second set of rules or a second artificial intelligence program stored in the memory unit. In a fifth embodiment, identifying the at least one WCD as being within a prescribed geographical area includes identifying an order transaction, in the prescribed geographical area, involving the at least one WCD.

In a sixth embodiment, the at least one communication is with respect to at least one business location and step 418 determines the geographical area based on a position with respect to the at least one business location. In a seventh embodiment, the at least one business location includes a first plurality of business locations and step 420 selects, using the processor, a second plurality of business locations from the first plurality of business locations, the second plurality including less than all of the business locations in the first plurality, generating at least one reminder includes generating respective reminders related to the business locations in the second plurality, and transmitting the at least one reminder includes transmitting the respective reminders. In one embodiment, selecting a second plurality of business locations includes using at least one of a set of rules or an artificial intelligence program stored in the memory unit.

In a ninth embodiment, step 422 accepts, using the interface element, a search query from the at least one WCD and the at least one communication includes information responsive to the search query. In a tenth embodiment, the at least one WCD includes a plurality of WCDs, identifying the at least one WCD as being within a prescribed geographical area includes identifying first and second WCDs from the plurality of WCDs; determining that a response to the at least one communication has not been received includes determining that a respective response has not been received from the first and second WCDs; generating at least one reminder includes generating first and second reminders, different one from the other, for the first and second WCDs, respectively, and transmitting the at least one reminder includes transmitting the first and second reminders to the wireless communications network for transmission to the first and second WCDs, respectively. In one embodiment, generating first and second reminders includes using at least one of a set of rules or an artificial intelligence program stored in the memory unit.

Alternately stated, a present invention method: generates and outputs promotional offer to an end user device; determine that an end user device is in a geographic region; retrieves promotional offers relevant to the geographic region; and transmits a reminder to the end device regarding outputted and available offers. In one embodiment, a present invention method: optimize reminders based on historical responses to transmitted communications, for example, redemption of transmitted offers; retrieve communication response information, for example, regarding promotional offer redemption; retrieve transmitted communications, for example, promotional offers, including reminder setting; adjust reminder settings based on historical response information; and store adjusted reminder settings.

The following should be viewed in light of FIGS. 3 and 4. Although the discussion infra is with respect to a present invention system, it should be understood that the discussion also is applicable to a present invention method. In one embodiment of a present invention system, the use of table-based, rules-based, or artificial intelligence-based processing, as described in commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007 is used to evaluate the response to communications, such as offers, and adjust respective reminders to optimize responses, such as redemption of offers. Reminders can be optimized based on, but not limited to the following: type of communication or reminder; parameters associated with the geographic region, such as extent of or composition of the region; number of communications or reminders made available; number of communications or reminders transmitted to WCDs; expiration dates for communications or reminders; number of times reminder is sent; or best location to transmit reminder.

With the proliferation of WCDs, such as personal computing and communications devices, it is now possible to provide one-to-one marketing with any one or more existing or prospective customers. Such marketing may include marketing messages or offers, discounts, coupons, or other incentives, including offers to purchase items, visit certain locations, encourage friends to sign up to a loyalty or marketing program or any one or more of numerous marketing offers or messages.

In a preferred embodiment of the present invention system, a location of a WCD having previously received a communication, such as an order offer, from a business entity, for example, a restaurant or a retail outlet, is determined. Such determination may be made using any applicable means, including, for example, using a method of triangulation of a given cell phone or PDA device. Methods to locate, within a given distance a given cell phone or other cellular device, e.g., a PDA equipped with cellular communications abilities, are well known by those of ordinary skill in the art and in the prior art. By considering the WCD's current location and/or by estimating a destination or route of travel, the present invention can better determine if the WCD is or will be in the general vicinity of a location for the business location, that is, within a specified geographical area with respect to the business location. Such knowledge can be used to determine when or if to generate and transmit reminders and to determine the format and content of the reminders.

In one embodiment, the present invention tracks individual and classes of existing or prospective customers so as to further improve results of the present invention. For example, in the event that limited transaction history information is available for an end user of a WCD receiving a communication, such as an offer, the present invention accumulates such information to determine when and how to generate and transmit reminders and what incentives, if any, to include with the reminders. The present invention can accumulate information regarding rejection and acceptance of offers and reminders, and other parameters regarding the offers and reminders such as types, incentives included, associated locations, items included, offer types, and discount levels.

The present invention leverages existing or future marketing systems, marketing programs, loyalty programs, sponsor programs, coupon programs, discount systems, incentive programs, or other loyalty, marketing, or other similar systems, collectively, “marketing systems” by adding programming logic to determine when or when not to make certain offers, or to provide a different or improved incentive to use certain ordering devices or payment methods, based upon, but not limited to, any one or more of:
1. One or more business, customer or sponsor objectives.
2. Location of a device used to enter a transaction or location or device that receives or displays a marketing message or offer or that is otherwise controlled or affected by one or more marketing systems, including, for example, at a point of sale (POS) Terminal, WCD, Internet Enabled Device, Cell Phone, Kiosk, Laptop or PC, or any other device, or a location, e.g., at a retail outlet, quick service restaurant, drive through, front counter, kiosk station, table, at home, on the road, passing by, walking by, driving by, walking or driving near to, entering or leaving a location, or any other device or location information available to any such marketing system(s).
3. Temporal parameters, such as, time of day, day of week, month, or year.
4. Any one or more data or variables available or accessible, including, for example, any customer, business or sponsor information, such as, membership in a loyalty or other marketing program, ordering preferences or history, current sales volumes or budgets or targets, current or planned local, regional or national marketing programs or objectives, device preferences, for example, use of a kiosk in preference to a front counter or other device, current speed of service, quality of service or other operating data, budgets, objectives or trends, etc.

In a further embodiment, the present invention employs any one or more or any combination of the following, including, but not limited to discriminating based upon:
1. Location
2. Transaction Entry Device
3. Customer Information or objectives
4. Business Information or objectives
5. Sponsor Information or objectives
6. Marketing Program Type
7. Opt In Information
8. Offer Type
9. Payment method or terms or conditions of payment
10. Marketing Message Contents
11. Marketing Offer Objectives
12. Expected or Actual System Results or tracking data
13. System determined discounts or other incentives required to achieve desired results
14. One or more table entries provided by one or more end users, for example, a system administrator
15. One or more rules provided by one or more end users, for example, a system administrator
16. One or more genetic algorithms or other AI based rules or determination methods
17. Any other information, data, rules, system settings, or otherwise available to the marketing system or disclosed invention or the POS system or other system designed to deliver one or more marketing messages, offers, or coupons, etc.
18. Any combination or priority ranking of any two or more of the foregoing

In another embodiment, the present invention determines which reminders to generate and transmit and the content of the generated reminders based upon other performance data or results. In a further embodiment, the present invention determines the impact of one or more reminders on a WCD end user's ability or proclivity to game or fish the present invention and avoid or cease making reminders and/or change the type of reminders or incentives provided to or suppressed for a given end user or class of end users. For example, if a WCD receives a reminder regarding a given location at a given time, the present invention may not transmit another such reminder if the end user responds to the reminder, or the present invention may not transmit another such reminder (if appropriate) until a certain predefined or otherwise determined delay, e.g., one month. This technique may be employed to help ensure that reminders, if or when accepted, are generally accretive and are not dilutive to existing sales and profits.

With a present invention system, retailers, businesses, advertisers, sponsors and other third parties can use proximity information or data to determine or to assist in determining when and to whom to transmit reminders. This further method of discrimination provides a means to improve overall marketing success, and aids in targeting existing or prospective customers by using or otherwise exploiting such information.

In one embodiment, reminders may be transmitted to a WCD within a location. In addition to or in the alternate, a location can transmit reminders to existing or prospective customers before the customers enter such establishment, for example, while walking or driving by the location. In another embodiment, reminders vary from WCD to WCD or from time to time, and/or one or more of these may be consistent regardless of the customer, or time or other information. In a further embodiment, where reminders vary, such reminders are determined via any applicable means and using any available information to make such determination, including, for example, any available customer, business or sponsor information and/or any one or more customer, business or sponsor objectives and/or any combination of the forgoing. In yet another embodiment, reminders are further determined or modified based upon information or needs or business objectives of one or more suppliers and/or competitors of such suppliers. For example, if a WCD is within a geographical area for a location selling competing items A and B, a reminder is sent regarding previously sent offers for one or both of the items along with respective incentives to respond to the reminders. In this fashion, product providers and/or producers and/or retailers or distributors may provide one or more incentives to respond to offers for one or more products, which reminders may or may not be influenced by or competitive with any other such offers.

In one embodiment, a present invention system determines when and what types of reminders to present based upon current or previous buying habits or any other available information regarding a WCD end user. If for example, an end user is a loyal customer for item A, the present invention may not include an incentive with the reminder and/or may send a different offer or message depending upon any known factors, for example, did the end user receive or act upon a reminder or offer for item B. If the end user did receive or act upon a reminder for item B, in another embodiment, the present invention includes in a reminder regarding item A, blandishments to purchase item A instead of item B, and/or provide incentives matching or exceeding incentives in a reminder for item B, and/or query such loyal (or other) customer to determine what such customer would require in a reminder for item A to respond to the reminder. In this fashion a competitive environment is created. In a further embodiment, the end user of a present invention system modifies the rules or method of operation so as to favor itself. For example, in the previous example, if the producer of item A were the sole end user of the present invention, the producer may choose to not share any part or all of any such customer information or may use knowledge of any reminder regarding item B to its benefit. In another example, if a grocery chain was the sole end user of the present invention, the end user may choose to provide equal access to the present invention or favor one or more of its suppliers based upon any one or more of its business objectives, for example, the profitability and/or perceived or actual quality or consistency or pricing of such one or more suppliers.

In one embodiment, reminders are determined, in whole or in part, by two or more competing entities, for example, if a WCD is in the geographical area of two or more restaurants for which the WCD has received communications, the present invention determines the content of the respective reminders for the competing entities, in whole or in part, based upon any one or more or a combination of any or all of the following, including, for example, the general distance of the WCD from the restaurants, willingness of one or more owners or operators of the restaurant to pay for the generation and transmission of respective reminders, or the probability the end user of the WCD will respond favorable to a reminder, such as implementing an offer included in a communication, and/or based upon a transaction history for the end user or the WCD, for example, is the end user already a loyal customer of one or more of the restaurants, or any other available information regarding the restaurant (for example, a business), customer or sponsor's goals, objectives and/or information, which determination may be made via any applicable means, including, for example, use of a table-based, rules based or AI based system, including use of any genetic algorithms to improve performance over time.

For example, if a WCD associated with a loyal customer of restaurant A is approaching an area that contains both a restaurant A and a restaurant B and the WCD has previously received offers from both restaurants, a present invention system licensed by a cell phone company, could transmit a reminder regarding the offer from restaurant B. As another example, if a present invention system were exclusively licensed by restaurant A, restaurant A could choose to only send a reminder regarding the offer for restaurant A or to increase the incentive included in such a reminder only in the event it is determined that the WCD is about to or does enter the parking lot for restaurant B or actually enters restaurant B. In another example, if restaurants A and B were both non-exclusive licensees of the disclosed invention, each could choose to send one or more reminders as applicable. Such reminders can be based, in whole or in part, upon whether or not a WCD having received earlier communications from the restaurants is approaching a competitive location and/or if the transaction history for an end user of the WCD is known. For example, it is known by one or both such restaurants that the end user visits one of the restaurants more often than the other, in which case, reminders can be made to encourage continued loyalty and/or to switch brands.

In another embodiment of the present invention, past buying information is used to determine reminders or incentives in reminders. For example, if a retail chain knows that one or more customers in its stores have previously purchased a High Definition Television (TV) set, and a WCD associated with such customer(s) are in a geographical area with respect to a store in the chain, the disclosed system determines that a reminder regarding previously sent communications for related products should be generated and transmitted. In a further embodiment, the reminder includes specific reference to the customer or the customer's purchase of the TV set.

In one embodiment, the present invention determines a location of a current or prospective customer. Such determination may be made using any applicable means, including, for example, using a method of triangulation of a given WCD, such as a cell phone or PDA device. Methods to locate, within a given distance a given cell phone or other cellular device, for example, a PDA equipped with cellular communications abilities, are well known by those of ordinary skill in the art and in the prior art. By considering a customer or prospective customer's current location or by estimating a destination or route of travel, a marketing system can better determine if such customer or prospective customer is or will be in the general vicinity of a given location, for example, a restaurant or retail outlet, or within a specific area within such an establishment. Such knowledge can be used to determine when or if to make certain offer types or what level of discount should be provided, if any.

For example, if a person with a cell phone has just passed by a quick service restaurant chain, the disclosed system could: a) determine if such cell phone owner is or is not an existing customer, b) if such person is not a customer such a system could provide such person with an offer to come into the location to purchase an introductory item or meal (which may or may not include a discount proposition), c) if such person is a current customer the present invention could further determine if such customer routinely visits such location anytime, at the current time, for example, comes often for lunch, but never for dinner, and other customer information may be assessed to determine what, if any offer should be made and what, if any discount should be provided to such customer. Once such information is made available to the present invention, the present invention can make better informed decisions as to the type of offers to make, if any, when, and at what discount level(s), if any.

For example, if a loyal quick service restaurant chain customer is passing by a particular restaurant during the dinner hours, and such customer regularly visits this or other restaurants for lunch, but rarely, if ever, visits this or other quick service restaurant locations for dinner, the present invention can offer a free or discounted item or meal if such customer visits now or at some future date during certain hours, for example, 5 pm to 11 pm.

In another embodiment, in order to receive or otherwise qualify to receive such targeted marketing messages or offers, end users, that is, existing or prospective customers are required to opt in to a cellular marketing program or some other loyalty program indicating their desire or providing permission for such marketing system or company to send one or more such marketing offers or messages. In this fashion, only those interested in such communications will be sent such communications.

In a further embodiment, such customers or prospective customers indicate the type of offers or the frequency of offers or the value of such offers, for example, amount or type of discount, etc., that they wish the present invention to consider before sending any one or more such offers. For example, a cell phone subscriber can opt in to a cellular marketing network, indicating a general willingness to accept offers, but then restrict the present invention from making certain offers or offer types or within certain categories, for example, such cell phone subscriber may be willing to accept discount offers from specific business entities but not from any others, or may accept from other retailers, but only when or if such other retailer's provide a discount greater than 20% off the usual price for the offered item or items. Using an interface to permit designation of such preferences, end users, for example, existing or prospective customers can provide the present invention with additional customer information that can help the present invention determine when or if such marketing offers are made and at what discount.

In one embodiment, end users identify themselves using overt actions, for example, by swiping a card, in other embodiments, in addition or in the alternative to providing such identification means overtly, such end users may identify themselves passively, including, for example, by providing a cell phone number, GPS identification number or IP address, or a license plate number. In another embodiment, the present invention uses such identification means to retrieve information about an end user, for example, customer, business or sponsor information, which information may be further used to better or optimally determine if an offer or marketing message should be sent or otherwise provided to said end user.

In one embodiment, the present invention further determines which offers to make or to suppress based upon other performance data or results. In another embodiment, the present invention considers the impact of one or more offers on a customer's ability or proclivity to game or fish the present invention and avoids or ceases making offers or changes the type of offers generated and transmitted for a given customer or class of customers. For example, if a customer receives one offer to visit a given location at a given time, the present invention does not make another such offer if such customer accepts said offer, or the present invention does not make another such offer or other similar offer until a certain predefined or otherwise determined delay, for example, one month. This technique is employed to help ensure that offers, if or when accepted, are generally accretive and are not dilutive to existing sales and profits.

In a further embodiment, proximal offers are sent to prospective customers having an identity previously provided by an existing customer, as described in commonly-owned U.S. patent application titled: “SYSTEM AND METHOD FOR PROVIDING INCENTIVES TO AN END USER FOR REFERRING ANOTHER END USER,” inventors Otto et al., filed concurrently, which application is incorporated by reference herein. In such cases, a customer refers a new or prospective member by providing a means to determine such prospective member's location identification means, for example, a cell phone number. Once this information is made available, such prospective customer receives a marketing message or offer based in whole or in part upon such prospective member's location. For example, if an existing quick service restaurant chain customer provides one or more prospective customer's cell phone number, a present invention system may wait until such prospective customer is near one of the quick service restaurant chain's participating locations and then send such prospective member a message or offer, providing the identity of the referring party along with such message or offer. In addition or in the alternate, a present invention system could monitor the general or other travel habits of such referral, for example, prospective member, and then send one or more marketing offers or messages based in whole or in part on such information. For example, if the present invention determines that a prospective member more frequently passes by a particular quick service restaurant chain location, offers are sent to the prospective member to visit the particular location as this location, as it would appear to be generally more convenient for such prospective member.

Thus, the present invention provides a means to further optimize or discriminate among existing or potential members or customers in determining which offers, offer types, marketing messages, coupons, or other communications should be sent or suppressed based upon such proximal information, habits, tendencies, patterns, locations, travel directions or any other proximal data. Using the present invention, retailers, businesses, advertisers, sponsors and other third parties can use proximity information or data to determine or to assist in determining when and to whom to make marketing offers or send marketing messages or provide discounts or other incentives. This discrimination provides a means to improve overall marketing success and aids in targeting existing or prospective customers by using or otherwise exploiting such information.

In one embodiment, proximity offers are made within an establishment. In addition to or in the alternate, such establishment can make offers to existing or prospective customers before they enter such establishment, for example, while walking or driving by such establishment. While inside an establishment, marketing messages or offers may be delivered to existing or potential customers via any applicable means, including a WCD, for example, via cell phone, PDA or via any other means of communication such as use of electronic shelf labels, displays, TV's, speakers, lights, etc. For example, as a customer is walking by or near a given retail display, for example, an “end cap” that has items that may be of interest to such customer, the present invention sends a marketing message or offer that may a) describe the item or items available for sale, including, for example, features, benefits, competitive advantages, etc., or b) provide an offer for sale which may or may not include a discount or other financial incentives, for example, a buy one get one free promotion or a rebate offer.

In another embodiment, marketing messages or marketing offers or incentives vary from customer to customer or from time to time, or in whole or in part are consistent regardless of the customer, or time or other information. In cases where offers vary, such offers can be determined via any applicable means and using any available information to make such determination, including, for example, any available customer, business or sponsor information or any one or more customer, business or sponsor objectives or any combination of the forgoing. Such offers or messages can be further determined or modified based upon information or needs or business objectives of one or more suppliers or competitors of such suppliers. For example, if while walking through the isles of a grocery store, a customer comes upon an “end cap” or an area designed to promote one or more items or brands, and such customer receives an offer to purchase, for example, buy two, two liter bottles of a beverage for the price of one. Such customer may accept such message or may receive an additional message, for example, buy two, two liter bottles of a competitor's beverage and get both for the price of one, plus one additional six pack of small cans of the competitor's beverage. In this fashion, product providers or producers or retailers or distributors may provide one or more incentives to purchase one or more products, which offers may or may not be influenced by or competitive with any other such offers.

In a further embodiment, marketing messages, content, offers, incentives, etc., are created or maintained centrally or in a distributed network, including, for example, locally. Such management may be accomplished via any applicable means available, including, for example, making use of existing, for example, off the shelf and/or customized tools that provide for such creating, management or distribution. In one embodiment, in an effort to further control or determine which offers to make or to determine which offers are generally more or less desirable, or to otherwise improve one or more aspects of the present invention, the present invention accesses certain information from existing systems, including, for example, existing point of sale (POS) databases, such as customer transaction data, price lists, inventory information or other in or above store, for example, location data, including, but not limited to data in a POS, back office system, inventory system, revenue management system, loyalty or marketing program databases, labor management or scheduling systems, time clock data, production or other management systems, for example, kitchen production or manufacturing systems, advertising creation or tracking databases, including click through data, impressions information, results data, corporate or store or location financial information, including, for example, profit and loss information, inventory data, performance metrics, for example, speed of service data, customer survey information, digital signage information or data, or any other available information or data, or system settings data.

In another embodiment, the present invention provides information to a potential purchaser of a product, informing him/her about any one or more customers in the area that have made a similar purchase. For example, if a prospective customer is seeking information about a particular car, the present invention provides information or a link to establish communications with other purchasers of the same or similar car or cars purchased from the same manufacturer or distributor/dealer, etc. In a further embodiment, such prior purchasers are first required to opt into such a program before any part or all of their information is supplied to such prospective customer(s). Such willingness may or may not include receipt of a fee for providing such information. Such fee may be paid upon providing the information, upon sharing of the information or upon a user of such information making a purchase, which purchase may or may not have been made based, in whole or in part, upon such information or any combination of the foregoing. In this manner, a network can be created to provide prospective buyers with access to information and opinions of previous buyers of the same or similar products, goods, or services. Such “word of mouth” networks are well known in society, but the present invention automates and facilitates such word of mouth communications among prospective and existing customers in ways not possible using manual social networks, including, for example, the hereinabove disclosed method of connecting prior buyers with prospective buyers, even in the case where such individuals or groups are unaware of each other's previous buying habits.

In one embodiment, in the event an existing customer's information is provided to a prospective buyer, such prospective buyer is requested or required to provide such existing customer with additional information concerning one or more products, goods or services of interest to such existing customer that such prospective customer may have purchased or is otherwise familiar with based upon such prospective customer's previous buying history.

In another embodiment, before sharing an existing customer's information with a prospective buyer, such prospective buyers prior buying history is provided or is analyzed, by the present invention or by the existing customer to determine if any such prospective customer's prior purchases are or may be of interest to such existing customer. In this manner, such existing customer may be permitted to determine if such prospective customer has any information of use to such existing customer before sharing any information of such existing customer with such prospective customer or before sharing such existing customer's identity.

In a further embodiment, rankings or scores are provided by users of such prior history or buying or satisfaction information so that potential future users of such information might better determine which information to use or accept and/or which information might be suspect. For example, if customer A purchases a car, and then provides feedback to prospective customers X, Y and Z, each of such prospective customers might rank the usefulness or accuracy of such information so that any future prospective customer might be advised as to other's perception of such customer A's ability to make or provide future purchase advice or information or feedback.

In one embodiment, the present invention improves results over time or with use of the invention. Such improvement or optimization can be accomplished via any means necessary including any of several methods well known in the art or as disclosed by applicants and incorporated herein by reference, including, for example, commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007; commonly-owned U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed May 2, 2008; and commonly-owned U.S. patent application titled: “METHOD AND APPARATUS FOR GENERATING AND TRANSMITTING AN ORDER INITIATION OFFER TO A WIRELESS COMMUNICATIONS DEVICE,” inventors Otto et al., filed May 2, 2008. For example, statistical methods can be used to determine which marketing messages, offers, incentives, content or other communications generally yield the desired or optimal or generally better results, or such results may be determined using one or more genetic algorithms, or a present invention administrator/operator can review results reports and then provide manual weighting criteria to further define or control the present invention, or a combination of these and other well known methods may be employed in any combination or in any order or priority.

In a further embodiment, a present invention offer includes a discount. Such discounts can be associated or applied to specific items within the offer, or to the entire offer contents. In one embodiment, discounts are determined based upon rules established by management of the present invention or as established or modified from time to time by any authorized personnel, or may be initially established or modified using a learning system, e.g., a genetic algorithm, such as programs 320. In any such case, the present invention can make use of any or all available information, including, but not limited to customer information. Discounts can be designed to maximize, minimize or optimize any one or more business or customer objectives as desired or indicated. In another embodiment, the discount, if any, is presented to the customer as a percentage discount or as a cents or other amount off discount.

In one embodiment, discounts in incentives are used/tried relatively sparingly to determine the price elasticity of customers, both as a whole and/or by class, group, demographics, type or order contents, base order amounts, and/or specific customer's buying habits and acceptance/rejection information. In this fashion, the present invention can, over time, yield optimal results by learning or otherwise determining what incentives, if any, are required given the known information. For example, if customer A never orders item 1 with item 2, the present invention could include in the offer a 10% discount to combine items 1 and 2 in an order. If the customer rejects such offer, the present invention could attempt the same or similar offer upon the next customer's order entry, but this time offer a larger discount, for a 20% discount. Once the present invention determines a customer's price point, and/or the customer becomes habituated to ordering the item or service in the offer, the present invention can reduce or eliminate related discounts or other incentives.

In another embodiment, the present invention, having acquired data regarding customer price elasticity and other information, uses such information to determine other offers for the same or generally similar customers, e.g., other customers who purchase item 1 but do not typically purchase item 2. In a further embodiment, using such logic, the present invention determines classifications of customers and leverage use of such information by providing ideal order offers that are also optimized from the location or location management perspective/objectives.

In a further embodiment, an administrator can add or change or otherwise modify the previous listing, or data, or determine the order of priority or preference of each such discrimination factors or preferences or data, including, for example, location, payment or device, ranking each in order of such preference or providing table, rules or other entries to provide or assist or to support determining which are preferred or the amount of incentive available or increased or decreased incentive, as a percentage or absolute or relative or other dollar or other calculation method to determine what offers, if any to make, at which locations, devices or payment methods or other discriminating factors, for example, customer or business preferences or customer, business, sponsor or other entity information, objectives, rules or other available information or rules or system settings. By providing or otherwise manually or automatically determining such rankings, the disclosed invention can initially or continuously evaluate potential marketing offers or messages and modify or deliver such marketing messages or offers or provide other incentives to drive a desired percentage of business or customer transactions to one or more particular devices, locations or payment methods.

In one embodiment, the present invention provides such incentives initially, or on an ongoing basis or only until certain objectives are achieved or certain customers or all customers are generally habituated to making use of such certain devices, locations or payment methods, after which, in certain embodiments, the present invention may cease, temporarily or permanently making such offers based upon such discriminating factors, or may reduce the difference in incentives, or may only periodically provide such full discounts or reduced discounts so as to reinforce such behavior. In another embodiment, a system administrator or other end user establishes such rules or conditions.

In a further embodiment, the present invention makes such determinations using an automated means. Such automated means includes, for example, a system that periodically or generally continuously tests different marketing messages, content, offers or incentives or other methods, for example, user interfaces, or other benefits or incentives, and based upon such testing, determine which offers or incentives or other benefits yield the desired results or frequency of use of any such locations, devices or payment methods. Such automated system may periodically cease making such offers or providing the same or similar incentives or other benefits once it is determined that the desired customer behavior has been established, habituated or otherwise persists without need for such continued offers, incentives or benefits. If such system subsequently determines that the desired behavior has ceased or fallen below a desired level, such system can then reinstate such offers, incentives or benefits. When reinstating such offers, incentives or benefits, the present invention can return to previously successful levels or can provide less or greater incentives, offers or benefits, on a temporary, periodic or permanent basis. Such reinstatement may be provided for all customers, certain customers, classes of customers, or only those customers that have ceased or have generally reduced their frequency of desired behavior or use of generally more desirable devices, locations or payment methods.

In one embodiment, each location associated with the present invention establishes its own rules or learns from local customer behavior or other available information. In another embodiment, the present invention shares some or all available information or results data among any two or more or all locations or locations that fall within a given area, region, geography, type, or other factors, such as menu pricing, customer demographics, etc., and makes use of such information to improve the present invention's ability to determine which offers to make, the extent or duration of offers or incentives or other benefits. For example, when using an AI based system, such as disclosed in commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007,” one location may discover or otherwise determine that a certain type, class or other offer or incentive or benefit is particularly effective. By sharing such information among other locations, for example, similar locations, the present invention can begin to make use of the same or similar incentives, offers or benefits in other generally similar locations or with other similar customers or classifications of customers so as to improve the performance of one or more other such locations or all locations. In this fashion, the present invention can learn which offers or incentives or benefits will more quickly or generally achieve the desired results or improve trends towards such results. Likewise, the present invention can more quickly determine which offers, incentives or benefits do not yield the desired results or determine how long such offers, incentives or benefits are required to achieve the desired results.

In a further embodiment, the present invention tests making or not making certain offers, incentives or providing certain benefits on a periodic basis within a single location or among a plurality of locations so as to determine the extent or requirement to make any such offers or to provide incentives or other benefits. For example, by testing making offers and not making offers, the present invention can determine if any such offers are required at all to drive business transactions to a kiosk or such a system can further determine the extent of any gaming, dilution, diversion or accretion. By alternating making and not making offers or by testing various levels of incentives or discounts, the present invention can better determine the optimal incentive, discount or benefits required, if any, to achieve the desired results, while minimizing or mitigating any undesirable effects of using or deploying such system. Such testing can be accomplished via any applicable or available means, including those previously disclosed by applicants herein and within the referenced applications, or randomly or using rules or AI based systems. By periodically testing or making changes to such offers, incentives or benefits, the present invention can continually strive to achieve the optimal mix and level of offers, discounts, marketing messages, marketing offers, benefits, loyalty or marketing program benefits or otherwise. By combining the use of one or more of a table, rules or AI based system, including, for example, as disclosed in the applications incorporated by reference herein, a more effective marketing system may be developed and deployed that achieves optimal or nearly optimal results over both the short and long term, without generally becoming static.

In one embodiment, the present invention tests customers of one or more locations using discounts or other marketing offers, while maintaining the regular prices at one or more other locations. By comparing the results data from such test and control groups of locations, the present invention can better determine which offers, discounts, etc., are accretive or provide net benefit or are subject to gaming, fishing or other fraudulent or undesirable activities. Such testing can be performed within a single unit as well, by periodically making and not making such offers to the same or similar customers or by randomly providing such offers or not making such offers. In another embodiment, the present invention makes use of a combination of such testing methodologies in order to best determine which offers yield optimal or the best results given the present invention information, parameters or any one or more customer, business, sponsor or present invention objectives. For example, the present invention tests in a single or group of stores certain new or untested offers, and, combines such test with a periodic offer, for example, toggling, between making and not making offers, which toggling, may be random, 50/50, or may be intelligently determined based upon system information, and continue such test for a period of time, for example, one month, while comparing results of such tests with a similar number of stores in a control group, and then, switch the process, for example, test within the original control group and stop making offers within the original test group. In this fashion the present invention determines the effects of turning on or off certain offers or types of offers and the effect of such offers on customers, customer buying habits, store or business results, or any other measures, including, for example, testing for dilution, diversion, accretion, gaming or fishing.

In a further embodiment, a system administrator is permitted to enter or modify or delete or otherwise provide offers using an interface provided for such purposes. When establishing messages or content of offers, such administrator or other end user may be further permitted to designate which messages or content are to be generally used when using a particular type of communications. For example, one type of message or content may be designated for use when communicating via cell phone and another message or content for email and still other versions for each or all of the other various methods of communications. In one embodiment, the present invention tests each provided message or content with each such communications method to determine, partially or wholly, which message or content yields the best or optimal results over time or based upon any available information, including, for example, any available or otherwise accessible customer, business or sponsor information or objectives or by tracking actual activities and results or changes in behavior as expected or predicted by customers or other end users or classes or categories of uses or by device, location or payment method.

In one embodiment, items, services, or incentives for an offer are determined or based upon any available information including, for example, one or more or any combination of any business objectives, or customer identification, customer information, customer objectives, or customer historic data such as buying habits, tendency to accept or reject any offers or similar offers, or based upon such acceptance with or without a discount, or the amount of or type of discount, willingness to accept specific items or classes of items, or whether or not such items are complementary to base order items, a usual, preferred, or last ordered items, general price elasticity as determined by prior ordering habits or those of similar customers, or classes of customers, or for a given store or location, or based upon the time of day, day of week, month, year, the weather, competitive information, such as information about current marketing campaigns, discounts, marketing offers, and like from one or more competitors.

In one embodiment, existing or prospective end users or customers receive one or more incentives, marketing messages or other benefits, which are provided by one or more third parties, including, for example, third party sponsors. For example, when a customer receives a reminder with a discount on a WCD, the WCD manufacturer pays part or all of such discount for some or all such offers, on a temporary, periodic or permanent basis, so as to encourage use of their equipment or software. In another example, such an offer may be partially or fully subsidized by an unrelated third party sponsor. For example, a reminder to a WCD includes an offer from a telecommunications company for an incentive if a WCD end user responds to the reminder will go to any quick serve restaurant chain location and views an advertisement for telecommunications company or fills out a survey or perform some other action or accept a subsequent or related optional or required offer, etc. In this fashion, third party advertisers, for example, sponsors, are able to achieve their marketing objectives, while businesses fulfilling orders associated with the reminder are able to increase their sales, while customers benefit financially or via other incentives, which incentives may be paid in whole or in part, temporarily, periodically or permanently by such third party sponsors.

The following is a listing of exemplary hardware and software that can be used in a present invention method or system. It should be understood that a present invention method or system is not limited to any or all of the hardware or software shown and that other hardware and software are included in the spirit and scope of the claimed invention.

1. Hardware: Promotional Offer Reminder system

2. Software: Promotional Offer Reminder generation program

The following is a listing of exemplary data bases that can be used in a present invention method or system. It should be understood that a present invention method or system is not limited to any or all of the databases shown and that other databases are included in the spirit and scope of the claimed invention.

1. Device database including: Device ID; Device type; Linked devices 1-n; Transaction history; and Communications, such as promotional offers 1-n

2. Communication, such as promotional offers, database including: Promotional offer ID; Promotional offer descriptor; Allowable device type 1-n; Device 1-n; and Promotional offer rules and conditions 1-n.

Thus, it is seen that the objects of the invention are efficiently obtained, although changes and modifications to the invention should be readily apparent to those having ordinary skill in the art, without departing from the spirit or scope of the invention as claimed. Although the invention is described by reference to a specific preferred embodiment, it is clear that variations can be made without departing from the scope or spirit of the invention as claimed.

What is claimed is:

1. A computer-based method for generating and transmitting a location based offer reminder, comprising the steps of:
storing, in a memory element for at least one specially programmed general-purpose computer, a record of at least one communication sent to at least one wireless communications device (WCD);
identifying, using a processor and an interface element for the at least one specially programmed general-purpose computer, the at least one WCD as being within a prescribed geographical area;
determining, using the processor, that a response to the at least one communication has not been received;
generating, using the processor, at least one reminder regarding the at least one communication; and,
transmitting, using the processor and the interface element, the at least one reminder to a wireless communications network for transmission to the at least one WCD.

2. The method of claim 1 wherein the at least one communication is an advertisement or an offer and the method further comprising the steps of:
generating, using the processor, the advertisement or the offer; and,
transmitting, using the processor and the interface element, the at least one communication to the wireless communications network for transmission to the at least one WCD.

3. The method of claim 1 wherein generating at least one reminder includes using at least one of a set of rules or an artificial intelligence program stored in the memory unit.

4. The method of claim 1 further comprising the step of determining, using the processor and at least one of a set of rules or an artificial intelligence program stored in the memory unit, the geographical area.

5. The method of claim 1 wherein the at least one communication includes a plurality of communications, wherein determining that a response to the at least one communication has not been received includes determining that a respective response to more than one communication in the plurality of communications has not been received, wherein generating at least one reminder regarding the at least one communication includes determining for which of the more than one communications to generate a respective reminder, and generating the respective reminders; and wherein transmitting the at least one reminder includes transmitting the determined respective reminders.

6. The method of claim 5 wherein determining for which of the more than one communications to generate a respective reminder includes using at least one of a first set of rules or a first artificial intelligence program stored in the memory unit or wherein generating the respective reminders includes using at least one of a second set of rules or a second artificial intelligence program stored in the memory unit.

7. The method of claim 1 wherein identifying the at least one WCD as being within a prescribed geographical area includes identifying an order transaction, in the prescribed geographical area, involving the at least one WCD.

8. The method of claim 1 wherein the at least one communication is with respect to at least one business location and the method further comprising the step of determining the geographical area based on a position with respect to the at least one business location.

9. The method of claim 8 wherein the at least one business location includes a first plurality of business locations and the method further comprising the step of selecting, using the processor, a second plurality of business locations from the first plurality of business locations, the second plurality including less than all of the business locations in the first plurality, wherein generating at least one reminder includes generating respective reminders related to the business locations in the second plurality, and wherein transmitting the at least one reminder includes transmitting the respective reminders.

10. The method of claim 9 wherein selecting a second plurality of business locations includes using at least one of a set of rules or an artificial intelligence program stored in the memory unit.

11. The method of claim 1 further comprising the step of accepting, using the interface element, a search query from the at least one WCD and wherein the at least one communication includes information responsive to the search query.

12. The method of claim 1 wherein the at least one WCD includes a plurality of WCDs, wherein identifying the at least one WCD as being within a prescribed geographical area includes identifying first and second WCDs from the plurality of WCDs; wherein determining that a response to the at least one communication has not been received includes determining that a respective response has not been received from the first and second WCDs; wherein generating at least one reminder includes generating first and second reminders, different one from the other, for the first and second WCDs, respectively, and wherein transmitting the at least one reminder includes transmitting the first and second reminders to the wireless communications network for transmission to the first and second WCDs, respectively.

13. The method of claim 12 wherein generating first and second reminders includes using at least one of a set of rules or an artificial intelligence program stored in the memory unit.

14. A computer-based system for generating and transmitting a location based offer reminder, comprising:
an interface element for at least one specially programmed general-purpose computer;
a memory element for the at least one specially programmed general-purpose computer, the memory element storing a record of at least one communication sent to at least one wireless communications device (WCD); and,
a reminder element, in a processor for the at least one specially programmed general-purpose computer for:
identifying, using the interface element, the at least one WCD as being within a prescribed geographical area;
determining that a response to the at least one communication has not been received;
generating at least one reminder regarding the at least one communication; and,
transmitting, using the interface element, the at least one reminder to a wireless communications network for transmission to the at least one WCD.

15. The system of claim 14 wherein the reminder element is for generating the at least one communication and for transmitting, using the interface element, the at least one communication to the wireless communications network for transmission to the at least one WCD.

16. The system of claim 14 wherein the reminder element is for generating the at least one reminder using at least one of a set of rules or an artificial intelligence program stored in the memory unit.

17. The system of claim 14 wherein the reminder element is for determining, using at least one of a set of rules or an artificial intelligence program stored in the memory unit, the geographical area.

18. The system of claim 14 wherein the at least one communication includes a plurality of communications and wherein the reminder element is for:
determining that a respective response to more than one communication in the plurality of communications has not been received;
determining for which of the more than one communications to generate a respective reminder;
generating the respective reminders; and,
transmitting the respective reminders to the wireless communications network for transmission to the WCD.

19. The system of claim 18 wherein the reminder element is for:
using at least one of a first set of rules or a first artificial intelligence program stored in the memory unit to determine for which of the more than one communications to generate a respective reminder; or,
using at least one of a second set of rules or a second artificial intelligence program stored in the memory unit to generate the respective reminders.

20. The system of claim 14 wherein the reminder element is for identifying an order transaction, in the prescribed geographical area, involving the at least one WCD.

21. The system of claim 14 wherein the at least one communication is with respect to at least one business location and wherein the reminder element is for determining the geographical area based a position with respect to the at least one business location.

22. The system of claim 21 wherein the at least one business location includes a first plurality of business locations and wherein the reminder element is for:
selecting a second plurality of business locations from the first plurality of business locations, the second plurality including less than all of the business locations in the first plurality;
generating respective reminders related to the business locations in the second plurality; and,
transmitting the respective reminders to the wireless communications network for transmission to the WCD.

23. The system of claim 22 wherein the reminder element is for using at least one of a set of rules or an artificial intelligence program stored in the memory unit to select the second plurality of business locations.

24. The system of claim 14 wherein the reminder element is for accepting, using the interface element, a search query from the at least one WCD and wherein the at least one communication includes information responsive to the search query.

25. The system of claim 14 wherein the at least one WCD includes a plurality of WCDs and wherein the reminder element is for:
identifying first and second WCDs from the plurality of WCDs;
determining that a respective response has not been received from the first and second WCDs;
generating and transmitting first and second reminders, different one from the other, for the first and second WCDs, respectively; and,
transmitting the first and second reminders to the wireless communications network for transmission to the first and second WCDs, respectively.

26. The system of claim 25 wherein the reminder element is for using at least one of a set of rules or an artificial intelligence program stored in the memory unit to generate the first and second reminders.
